(19) United States
(12) Patent Application Publication
(10) Pub. No.: US 2005/0257901 A1
(43) Pub. Date: Nov. 24, 2005

(54) Garage doors reinforcement system

(76) Inventor: Allen Berger JR., Hialeah Gardens, FL (US)

Correspondence Address: Sanchelima and Associates, P.A.;Jesus Sanchelima, Esq., 235 S.W. Le Jeune Rd., Miami, FL, 33134, US

(21) Appl. No.: 10/822,079

(22) Filed: Apr. 12, 2004

(51) Int. Cl. E06B 3/48

(52) U.S. Cl. 160/229.1

(57) ABSTRACT

An improvement for reinforced garage doors that includes using horizontally disposed reinforcement runner members with a longitudinal complementary shape that conform to the longitudinal complementary joints of the panel ends, such as the tongue and groove type or the shiplap type, or equivalent. The reinforcement runner members are made with roll forming processes by creating several longitudinal folds. The reinforcement runner members extends, uninterrupted, the entire width of the panels and enhance the articulation of the panels.

### BACKGROUND OF THE INVENTION

1. Field of the Invention

The present invention relates to a garage door reinforcement system that is interiorly disposed.

2. Description of the Related Art

Several inventions for reinforcements for garage doors have been developed in the past. None of them, however, includes an additional reinforcement member conforming to the structure that extends continuously and transversally across a door panel. The present invention eliminates the U-shaped bars that are externally mounted at present while enhancing its structural integrity.

Typically, garage doors have multiple panels with multiple widths, with a panel height of 21 inches, preferably, and modular lengths of 8; 9; 12 and 16 feet (2.44; 2.74; 3.66; 4.88 meters, respectively). The most popular designs include four panels that are monolithic throughout the entire length, each having lateral top and bottom edges. These edges have a tongue and groove, shiplap, or equivalent terminations. These terminations are intended to provide structural reinforcement and also act as a barrier to the elements, including water and wind.

Construction codes in several areas, specifically those that are prone to windstorms and hurricanes, require passing certain wind tests. Thus, the need for reinforcements for garage doors. Typically, garage doors are not prepared to withstand strong winds experienced in many parts of the world. These additional reinforcements are not needed in some areas. There is a need for reinforced garage doors, capable of passing hurricane wind tests for each jurisdiction, on a selective basis. Thus, a system for readily reinforcing the doors, when needed, is quite desirable.

Applicant believes that the closest reference corresponds to U.S. Pat. No. 6,062,293 issued to Allen Berger, Jr., who is the inventor in the present application, for a garage door reinforcement and method. The present invention improves the wind load resistance of the garage door even more by having reinforcement bars that conform to the shaped of existing structural folded members without detracting from the aesthetics of the door.

The present invention provides a reinforcement assembly that conforms and follows the lateral edges of a garage door panel. The present invention includes a reinforcement that is compatible with the panels' terminations, namely, tongue and groove, shiplap and others. The reinforcement bar is made with folding manufacturing techniques.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide an interior garage door reinforcement system that is capable of withstanding high winds and flying objects without adversely affecting the aesthetics of the door.

It is yet another object to provide a garage reinforcement system that enhances its structural integrity by adding reinforcement members that complement and abuttingly conform to the main structural members of the door.

It is still another object of this invention to provide a garage door reinforcement system made for standard sized panels, to fit standard sized tracks, in standard sized garages, and yet effective to withstand wind loads of hurricane grade and using roll forming manufacturing processes.

It is yet another object of this invention to provide such a system that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an isometric view the garage door, object of the present application.

FIG. 2 shows a cross section view of the present invention, taken along line 2-2 in FIG. 1.

FIG. 3 illustrates an enlarged isometric view of one section of the present invention partially showing two adjacent panels.

FIG. 4 is an exploded view of the portion represented in FIG. 3, showing the reinforcing bars of the present invention being mounted.

FIG. 5 represents an exploded view of an alternate embodiment, showing the shiplap type complementing joint portion and the conforming shiplap type reinforcing bars.

FIG. 6 is a representation of a front elevational view of an alternate embodiment using shiplap type complementing joint portion and conforming shiplap type reinforcing bars.

### DETAILED DESCRIPTION OF THE PREFERRED EMBODIMENT

Referring now to the drawings, where the present invention is generally referred to with numeral 10, it can be observed that it basically includes, in the preferred embodiment, several panel sections 20, reinforcement runner member 50, reinforcement runner member 60 and hinge assembly 80.

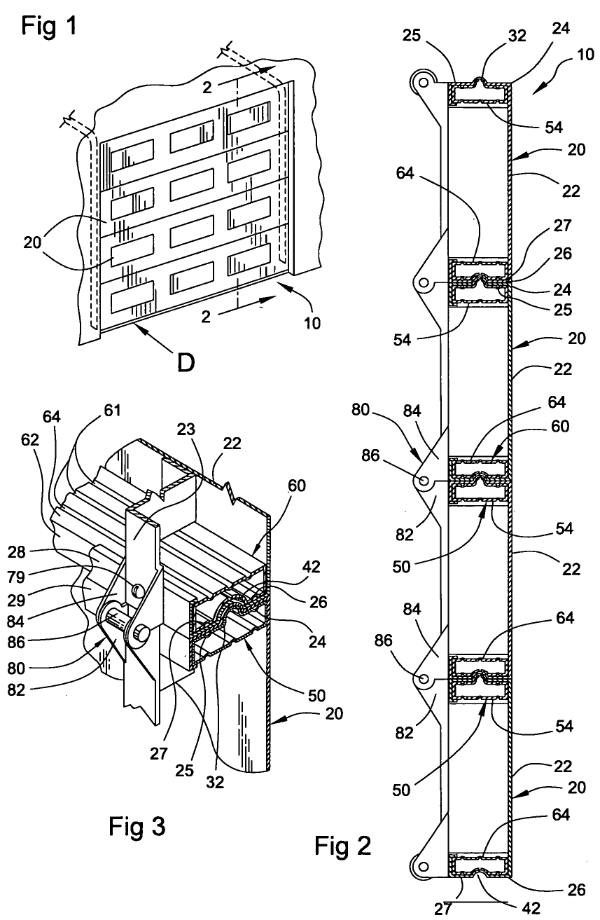

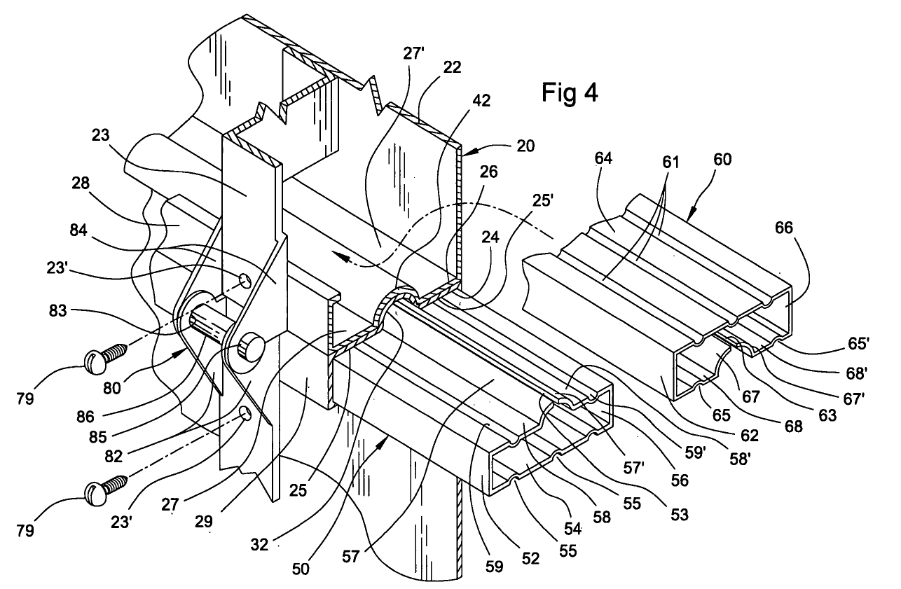

As seen in FIG. 1, panel sections 20 run the entire width of door D and are hingedly mounted to each other with hinge assemblies 80. As best seen in FIGS. 2; 3 and 4, each panel section 20 includes wall 22 with reversely folded edge portions forming upper longitudinal end 24 and lower longitudinal end 26, extending therefrom. The reversely folded edge portions form upper longitudinal ends 24 and lower longitudinal ends 26 are articulated to each other in contiguous panels. In the preferred embodiment shown in FIGS. 1 through 4, ends 24 and 26 are complementing joints of the tongue and groove type. In the preferred embodiment, upper longitudinal end 24 includes longitudinally extending upper wall 25 with longitudinal tongue 32 and longitudinally extending inner wall 29 perpendicularly extending from upper wall 25, as best seen in FIG. 4. Lower longitudinal end 26 includes longitudinally extending bottom wall 27 with longitudinally extending groove 42 and longitudinally extending inner wall 28 perpendicularly extending from bottom wall 27. Longitudinal tongue 32 and longitudinally extending groove 42 are intended to provide reinforcement to ends 24 and 26, respectively, and protection from the elements. Wall 22 is vertically disposed when door is closed.

Hinge assembly 80 includes walls 23 with angular walls 82 and 84 at its upper and lower ends, respectively. Angular walls 82 cooperate with angular walls 84 of a contiguous panel section 20 to receive hinge pin 86 through openings 83 and 85, respectively. Through openings 23′ of wall 23 permit fastening members 79 to go through and selectively engage holes cooperatively positioned on walls 28 and 29 and runner members 50 and 60, respectively.

In the preferred embodiment for garage door reinforcement system, longitudinal unitary reinforcements as reinforcement runner members 50 and 60 are insertable horizontally and interiorly to the complementing top and bottom joints, namely upper longitudinal end 24 and lower longitudinal end 26, respectively. Reinforcement runner member 50 includes longitudinally extending walls 52; 54; 56; 58 and 58′ and extends along the entire width of door D, as shown in FIGS. 3 and 4. Wall 54 includes small longitudinal grooves 55 to enhance its strength. Walls 52 and 56 extend perpendicularly from wall 54 and both fold to define walls 58 and 58′. These walls extend as a mirror of each other and are separated by longitudinally extending space 53. Walls 58 and 58′ also include, in the preferred embodiment, small reinforcing longitudinal grooves 59 and 59′ and complementing longitudinal curved portions 57 and 57′ that conform to longitudinal tongue 32.

Reinforcement runner member 60 includes longitudinally extending walls 62; 64; 66; 68 and 68′ and extends along the entire width of door D, as shown in FIG. 4. Wall 64 includes small longitudinal grooves 61 to enhance its strength. Walls 62 and 66 extend perpendicularly from wall 64 and both fold to define walls 68 and 68′. Walls 68 and 68′ extend as a mirror of each other and are separated by longitudinally extending space 63. Walls 68 and 68′ also include, in the preferred embodiment, small reinforcing longitudinal grooves 65 and 65′ and complementing longitudinal curved portions 67 and 67′ that conform to longitudinal groove 42.

The manufacture of reinforcement runner members 50 and 60 is compatible with inexpensive roll forming processes. The function of reinforcement runner members 50 and 60 is to enhance the structural integrity of ends 24 and 26, respectively, by having complementary longitudinally curved portions 67 and 67′ come in longitudinal contact and conforming to the shape of longitudinally extending groove 42. Similarly, complementary longitudinally curved portions 57 and 57′ come in longitudinal contact and conforming to the shape of longitudinally extending tongue 32. The result is a structure of superior strength. The otherwise vulnerable articulations of the panels are strengthened.

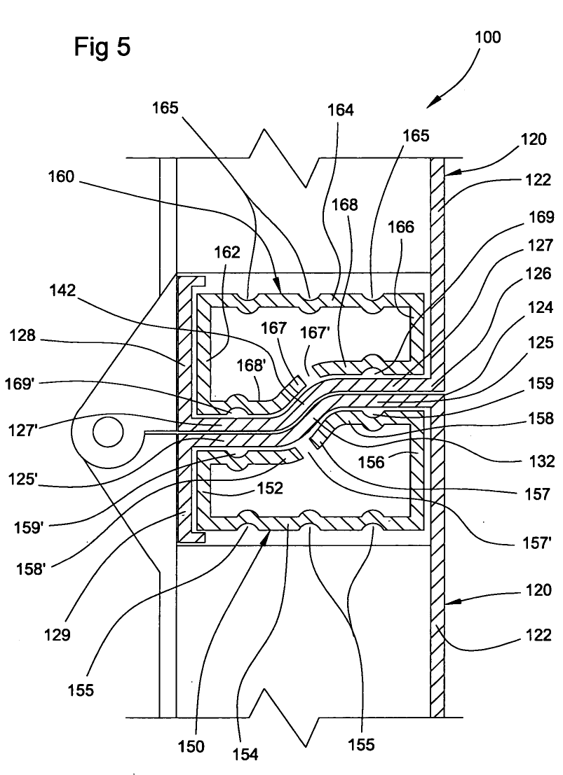

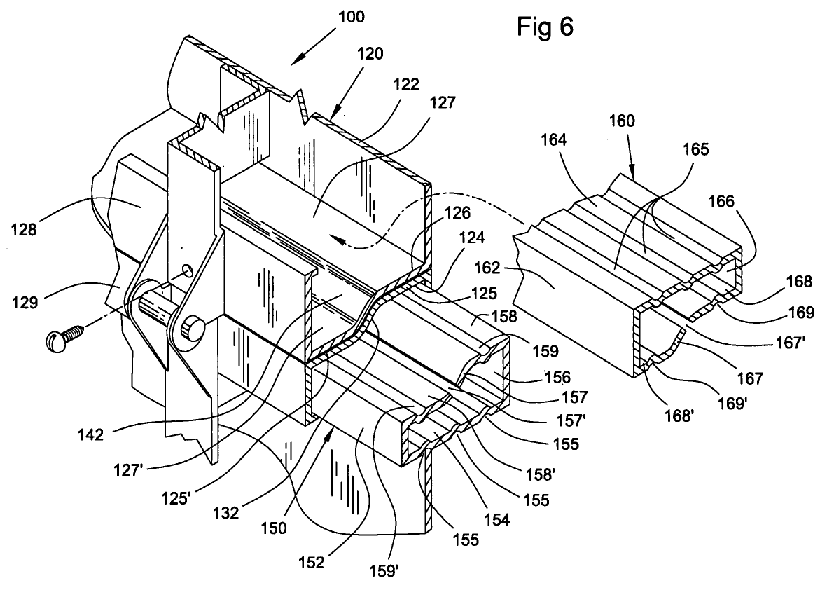

In the alternate embodiment 100 shown in FIGS. 5 and 6, each panel section 120 includes wall 122 with upper and lower longitudinal ends 124 and 126, extending therefrom. Upper and lower longitudinal ends 124 and 126 conform ship lap type complementing joints along the top and bottom edges of panel sections 120. Upper longitudinal end 124 includes longitudinally extending upper walls 125 and 125′ with curved portion 132 and longitudinally extending inner wall 129 in a parallel relationship with respect to panel section 120. Lower longitudinal end 126 includes longitudinally extending bottom walls 127 and 127′ with curved portion 142 and longitudinally extending inner wall 128 in a parallel relationship with respect to panel section 120. Shiplap type upper and lower longitudinal ends 124 and 126 cooperatively engages as a shiplap type complementing joint, as best seen in FIG. 6.

As best seen in FIG. 6, longitudinal unitary reinforcement runner members 150 and 160 are of the shiplap type and they are insertable horizontally and interiorly to the complementing joints, namely upper longitudinal end 124 and lower longitudinal end 126. Reinforcement runner member 150 includes longitudinally extending walls 152; 154; 156; 158 and 158′ and extends along the entire width of door D. Wall 154 includes small longitudinal grooves 155. Walls 152 and 156 extend perpendicularly from wall 154. Walls 158 and 158′ define the shiplap type complementing joint. Walls 158 and 158′ also include small reinforcing longitudinal grooves 159 and 159′, respectively, curved portion 157 with a longitudinally extending space 157′ at its central portion.

Reinforcement runner member 160 includes longitudinally extending walls 162; 164; 166; 168 and 168′ and extends along the entire width of door D. Wall 164 includes small longitudinal grooves 165. Walls 162 and 166 extend perpendicularly from wall 164. Walls 168 and 168′ define the shiplap type complementing joint. Walls 168 and 168′ also include small reinforcing longitudinal grooves 169 and 169′, respectively, curved portion 167 with a longitudinally extending space 167′ at its central portion.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

1. A reinforced garage door in which said garage door has a plurality of panels, having a horizontal width and a vertical height, which panels are monolithic for the entire length of the panels, with adjacent panels above such panels having reversely folded edge portions with complementing joints along the top edge and the bottom edge, such panels having open end members, open reinforcing members space vertically and interiorly of the door, and means for securement at the extreme lateral edges to a track for raising and lowering the door, the improvement comprising a plurality of longitudinal unitary reinforcement members insertable horizontally and interiorly of the complementing joints top and bottom longitudinal reversely folded edge portions of the panel from one end thereof to the other uninterrupted and having conforming longitudinal portions for said complementing joints and coming in abutting longitudinal contact with the latter.

2. The reinforced garage door set forth in claim 1 wherein said reinforcement is formed with first, second, third, fourth and fifth folded longitudinal walls, said first and second walls being parallel and spaced apart by said third wall to which the former are perpendicularly mounted, and said fourth and fifth walls being inwardly folded from said first and second walls and said fourth and fifth walls kept next to each other in the same plane, said fourth and fifth wall conforming to the contour of said complementing joints.

3. The reinforced garage door set forth in claim 2 wherein said complementing joints are of the tongue and groove type and said conforming longitudinal portions are also of the tongue and groove type.

4. The reinforced garage door set forth in claim 2 wherein said complementing joints are of the shiplap type and said conforming longitudinal portions are also of the shiplap type.
